(19) United States
(12) Patent Application Publication
(10) Pub. No.: US 2009/0034710 A1
(43) Pub. Date: Feb. 5, 2009

(54) TELEPHONE SYSTEM AND EXCHANGE APPARATUS THEREFOR

(75) Inventors: Rumi Suzukawa, Hino-shi (JP); Fumio Shibasaki, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/172,575

(22) Filed: Jul. 14, 2008

(30) Foreign Application Priority Data
Jul. 31, 2007 (JP) 2007-199368

(51) Int. Cl. H04M 7/00

(52) U.S. Cl. 379/220.01

(57) ABSTRACT

According to one embodiment, there is provided a telephone system comprises an exchange apparatus to be connected to a best-effort type network and a telephone terminal to be connected to the exchange apparatus. The exchange apparatus includes a first interface unit which is connected to the best-effort type network, a second interface unit which forms a communication route differing from the first interface unit, a detection unit which detects deterioration in a quality of service of a call during establishment between the telephone terminal and its partner via the first interface unit and the best-effort type network, and a call moving unit which moves the call to a communication route passing through the second interface unit when the deterioration is detected.

### CROSS-REFERENCE TO RELATED APPLICATIONS

This application is based upon and claims the benefit of priority from Japanese Patent Application No. 2007-199368, filed Jul. 31, 2007, the entire contents of which are incorporated herein by reference.

### BACKGROUND

1. Field

One embodiment of the present invention relates to a telephone system in which telephone terminals actualize voice communications via, for example, the Internet Protocol (IP), and an exchange apparatus for use in this kind of telephone system.

2. Description of the Related Art

In recent years, a so-called Voice over IP (VoIP) which makes voice communication by using the IP network has become widely used as the telephone system. In such a kind of telephone system, a voice packet may pass through an open network such as the Internet. Therefore, a technique with a high level is required in order to maintain a quality of service (QoS) of communication, and especially, examination on a technique for making a communication link detour against a failure.

A related technique is disclosed in Jpn. Pat. Appln. KOKAI Publication No. 2002-77265. This patent document discloses a technique for making a call to be originally connected to the IP network detour to other network such as the Integrated Service Digital Network (ISDN). However, a communication channel is fixedly selected at the time of generation of the call by the technique disclosed in this document. Therefore, the communication link which has been established cannot be moved to another network.

As mentioned above, when the QoS has been deteriorated, the existing technique may move the call in advance before being established to the network with high quality; however it is hard to make the communication link which has already been established detour to other network, and a technique of some sort has been expected to be developed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system view depicting an embodiment of a telephone system regarding the invention;

FIG. 2 is a functional block diagram depicting embodiments of exchange apparatuses 200, 300 of FIG. 1;

FIG. 3 is a functional block view depicting embodiments of LAN interface units 121-12n of FIG. 2;

FIG. 4 is a view depicting an example of a priority setting table 15a of FIG. 2;

FIG. 5 is a view depicting an example of default setting of the table 15a;

FIG. 6 is a view depicting an example of another example of the default setting of the table 15a;

FIG. 7 is a view depicting an example of communication information to be stored in a communication information storage unit 12c;

FIG. 8 is a view depicting a sequence to be performed in moving a call in communication in the telephone system of FIG. 1;

FIG. 9 is a flowchart depicting a processing procedure in moving a call to be performed by a requester of FIG. 8;

FIG. 10 is a flowchart depicting a processing procedure in moving a call to be performed by a responder of FIG. 8; and

FIG. 11 is a sequence view depicting a moving procedure of a call by using a session initiation protocol (SIP).

### DETAILED DESCRIPTION

Various embodiments according to the invention will be described hereinafter with reference to the accompanying drawings. In general, according to one embodiment of the invention, a telephone system comprises an exchange apparatus to be connected to a best-effort type network and a telephone terminal to be connected to the exchange apparatus. The exchange apparatus includes a first interface unit which is connected to the best-effort type network; a second interface unit which forms a communication route differing from the first interface unit; a detection unit which detects deterioration in a quality of service of a call during establishment between the telephone terminal and its partner via the first interface unit and the best-effort type network; and a call moving unit which moves the call to a communication route passing through the second interface unit when the deterioration is detected.

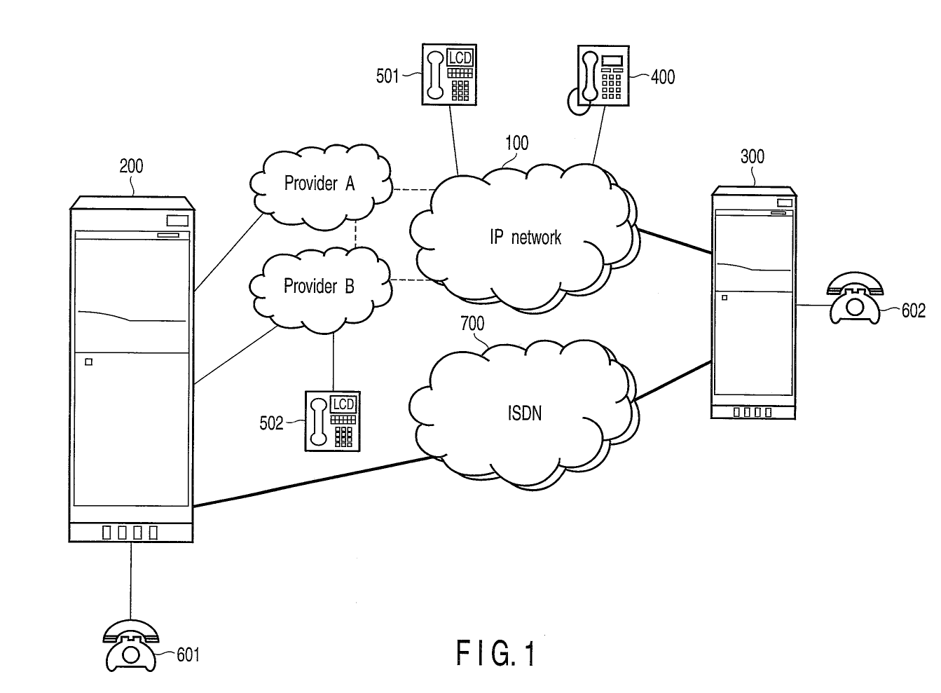

According to an embodiment, FIG. 1 shows a system view depicting an embodiment of a telephone system regarding the invention. The telephone system includes exchange apparatus 200, 300 to be mutually connected via an IP network 100. Among of them, the exchange apparatus 200 is connected to the IP network 100 via unique networks of providers A, B. An IP terminal 400 and an IP extension terminal 501 are connected to the IP network 100, and an IP extension terminal 502 is connected to the unique network of the provider B. An extension terminal 601 and an extension terminal 602 are connected to the exchange apparatuses 200 and 300, respectively. The exchange apparatuses 200, 300 form a VoIP communication environment among these terminals 400, 501, 502,601 and 602. That is, the exchange apparatuses 200, 300 form the VoIP communication environment via the IP network 100.

Further, the exchange apparatuses 200, 300 are mutually connected via ISDN 700. Each of the terminals also may communicate with one another via the ISDN 700 by the control from the exchange apparatuses 200, 300. In FIG. 1, the IP network 100 is a best-effort type communication network such as a local area network (LAN) or a wide area network (WAN). In contrast, the ISDN 700 is a guarantee type communication network which can secure constant QoS.

The protocol to be used in the telephone system shown in FIG. 1 is represented by the Session Initiation Protocol (SIP).

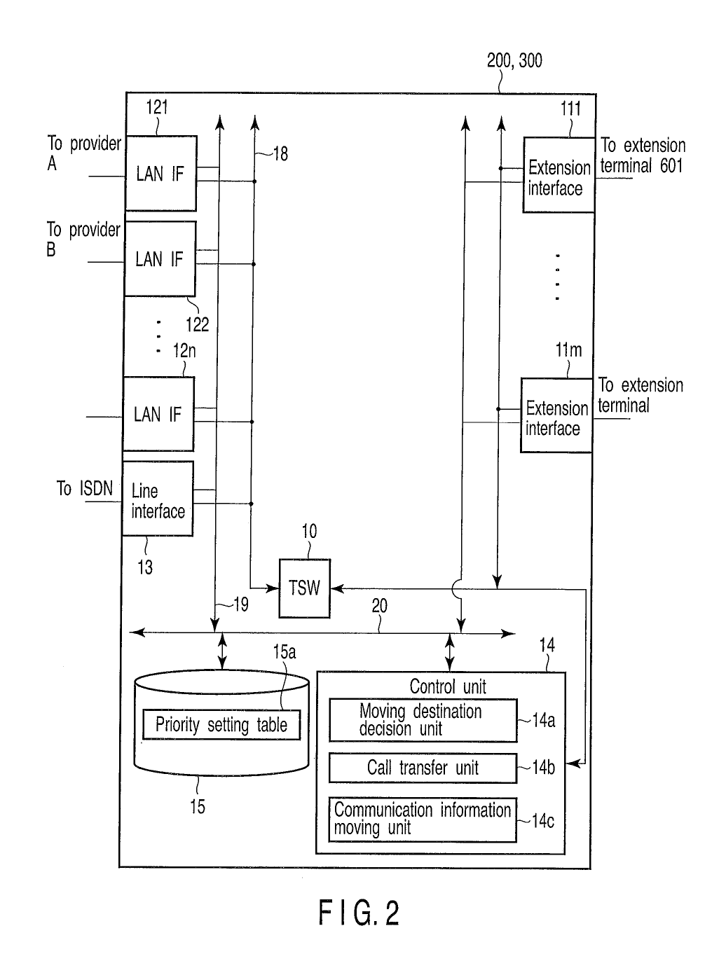

FIG. 2 shows a functional block view illustrating the embodiment of the exchange apparatus 200 of FIG. 1. The exchange apparatus 300 has the same configuration as that of the exchange apparatus 200. The exchange apparatus 200 includes extension interface units 111-11m, LAN interface units 121-12n, and line interface unit 13. The LAN interface units 121-12n have functions to process the IP, among of them, the LAN interface unit 121 and LAN interface unit 122 are connected to the provides A, B, respectively. The line interface unit 13 is connected to the ISDN 700. The extension interface unit 111 is connected to the extension terminal 601.

Each of the interface units 111-11m, 121-12n, 13 is connected to a control unit 14 via a control bus 19, and performs interface processing between the inside and the outside of the device under the control by the control unit 14. A signal from the outside is converted into pulse coded modulation (PCM) data by each of the interface units, and transmitted to a time switch 10 via a PCM bus 18. The time switch 10 applies time-division switching to the PCM data to established a communication route for each call.

The control unit 14 includes a moving destination deciding unit 14a, a call moving unit 14b and a communication information moving unit 14c as processing functions of the embodiment. When the moving destination deciding unit 14a is reported the deterioration in QoS of calls from the LAN interface unit 121-12n, the deciding unit 14a decides other interface units to move the calls. The moving unit 14b moves the calls to the decided interface units by using a moving function, etc. The information moving unit 14c moves communication information (digital signal processor [DSP] parameter, etc.) regarding the moved calls to the interface units at the moving destinations.

The storage unit 15 stores the priority setting table 15a therein. The table 15a is a database in which the order of priority of the interface units to be the moving destinations of the calls for each LAN interface unit 121-12n is defined in advance to make a database.

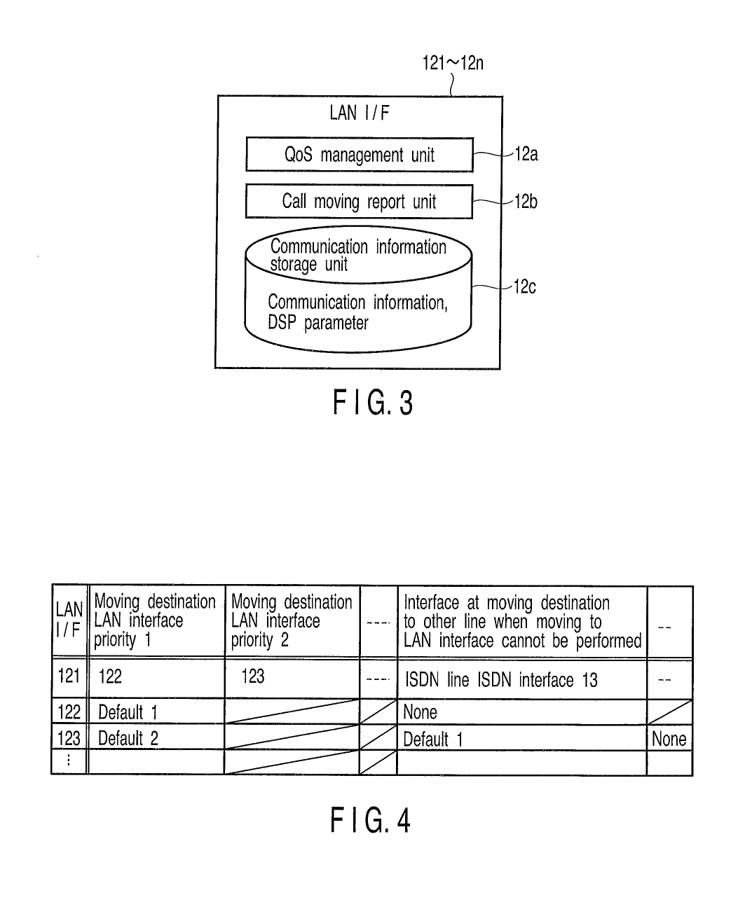

FIG. 3 shows a functional block view illustrating each embodiment of the LAN interface units 121-12n of FIG. 2. The LAN interface units 121-12n each includes a QoS management unit 12a, a call moving report unit 12b and a communication information storage unit 12c. The QoS management unit 12a manages each QoS of calls regarding their own interface units, and if detects calls which are deteriorated in QoS in comparison with defined threshold, reports the fact to the control unit 14. For detecting the deterioration in QoS, for example, the presence or absence of a failure due to RTCP/QoS is adopted.

When a call to move an interface unit is detected, the call moving report unit 12b reports the fact to move the call to a communication partner (a telephone terminal). The communication information storage unit 12c stores its communication information for each call regarding the own interface unit. The communication information includes, for instance, a various kinds of setting information of a DSP parameter and an echo canceller.

FIG. 4 shows a view an example of the priority setting table 15a of FIG. 2. On this table 15a, a top priority moving destination interface unit (priority 1) for each of the LAN interface units 121-12n, the next top priority moving destination interface unit (priority 2) for each of them 121-12n, etc., are established. In many cases, although the moving destination is any one of other LAN interface units, if the call cannot be moved to any one of the LAN interface units 121-12n, the moving, for example, to the line interface unit 13 (ISDN) is established.

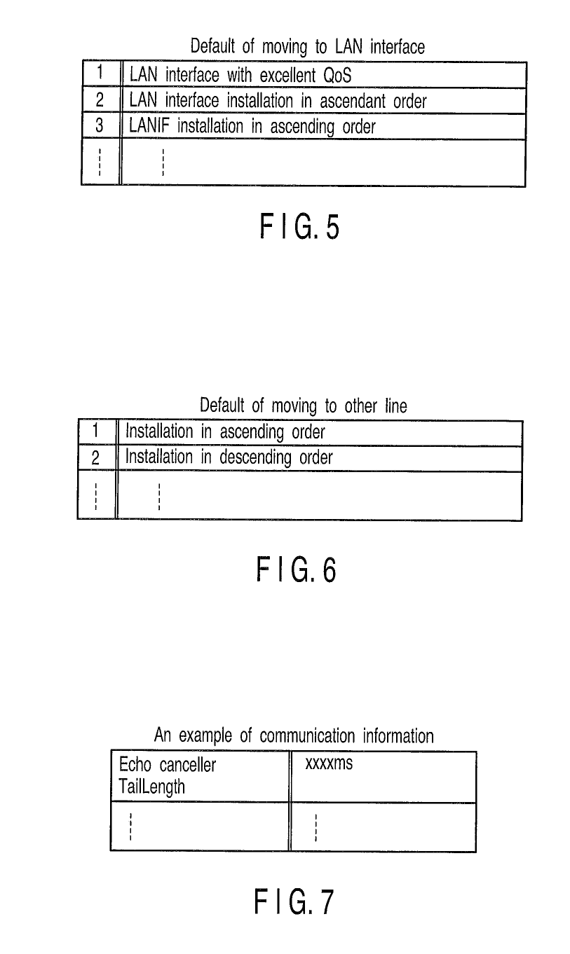

In FIG. 4, for example, for the LAN interface unit 122, the top priority moving destination is set as a default 1. The default 1 indicates a parameter to set the order of priority of the moving destination interface units in further detail as shown in FIG. 5. The default 1 of FIG. 5 shows preferentially selecting the LAN interface units having the large number of free channels. The default 2 of FIG. 5 shows preferentially selecting the LAN interface units on the basis of the order of the QoS. The moving destination deciding unit 14a refers to these parameters. FIG. 6 shows default setting parameters to decide the moving to other lines (the line interface unit 13, etc). For instance, the order priority of other lines may be decided on the basis of ascending order and descending order of installation.

FIG. 7 shows an example of the communication information to be stored in the storage unit 12c. The communication information is stored individually for each of the LAN interface units 121-12n. As shown in FIG. 7, the storage unit 12c stores information such as a length of a period of a ‘Tail Length’ of the echo canceller. The information is moved among interface units as the moving of the calls. Next, operations of the foregoing configuration of the exchange apparatuses 200, 300 will be described.

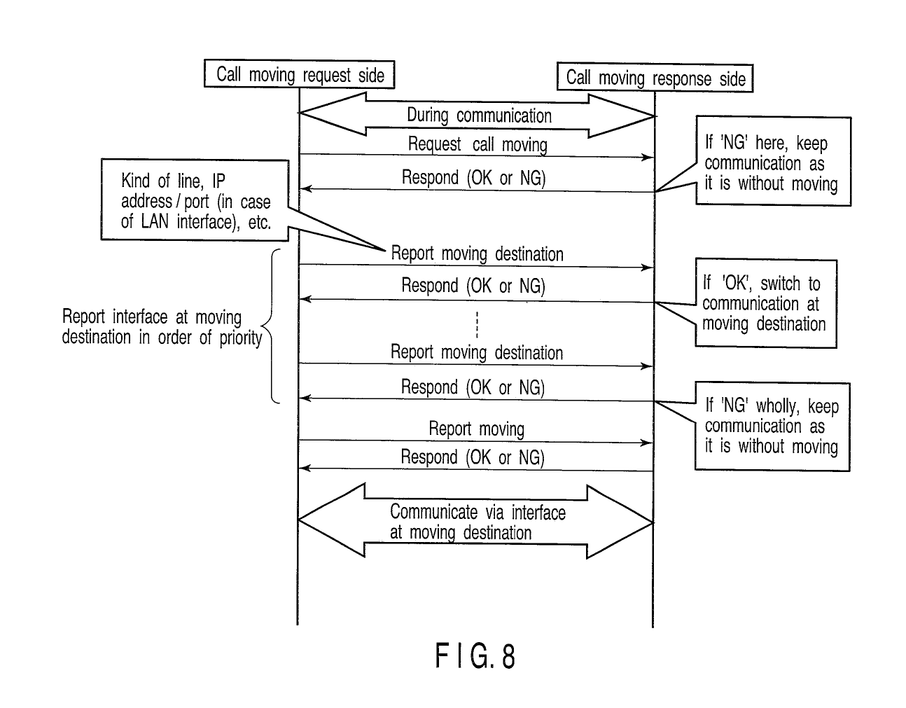

FIG. 8 shows a sequence which is performed for moving the calls in communication of this embodiment. The sequence is mainly performed by the side of requesting for the moving calls, namely the interface unit (call moving request side) which has detected the deterioration in QoS and the side of being reported the moving (call moving response side). The call moving response side includes the interface unit or the telephone terminal of the communication partner.

In FIG. 8, when the call moving request side (hereinafter referred to as a requester) detects the deterioration in quality in communication (QoS), a call moving request message is reported to the call moving response side (hereinafter referred to as a responder). The responder returns a response of ‘OK’ or ‘NG’ in response to the request message to a request origin, and if the response means ‘NG’, the call is not moved. If the response means ‘OK’ (allowable), the requester reports a moving destination report message including a kind of a line, an IP address/port number of the interface unit of the moving destination to the responder. The procedures are repeated in order of the priorities of the moving destination interface units until an ‘OK’ message is returned from the responder. If the responses to all the moving destination report messages are ‘NG’ messages, the call is not moved, if the ‘OK’ message is returned, the call is moved to the interface unit selected at that time. After this, the communication is continued through the interface unit at the moving destination.

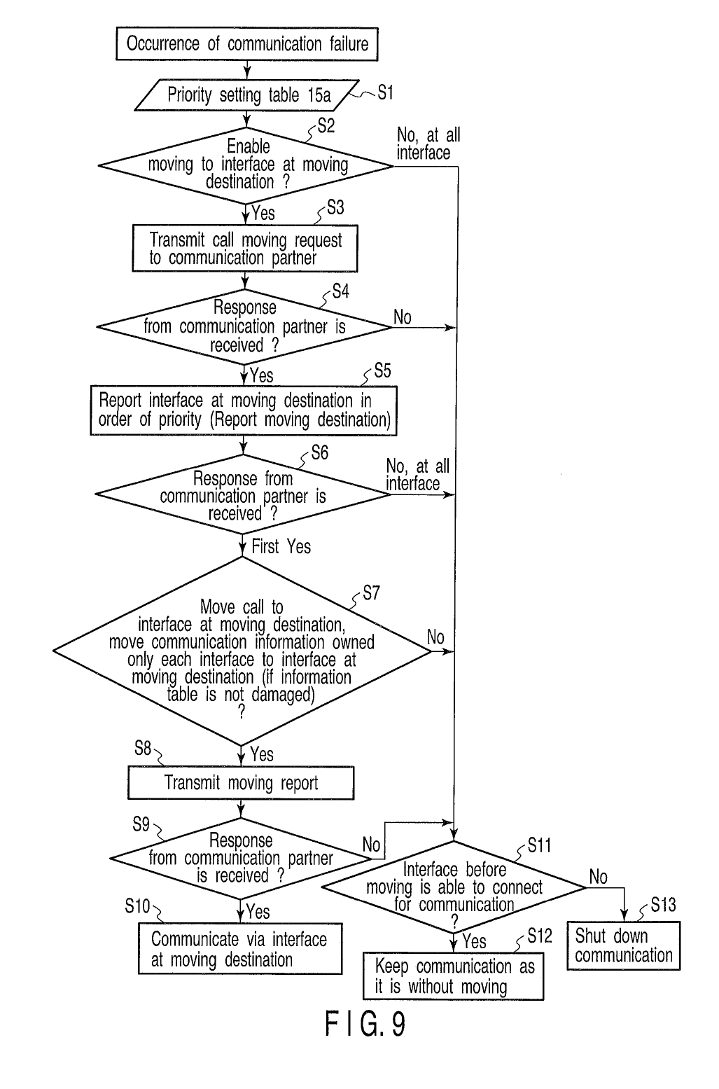

FIG. 9 shows a flowchart illustrating a processing procedure when the moving of the call is performed by the requester of FIG. 8. When the requester, namely any one of the LAN interface units detects a communication failure, the requester refers to the priority setting table 15a (Block S1). As a result, if the call may moving to any one of interface units (Yes in Block S2), the requester transmits a call moving request message to the communication partner (Block S3). If the response is received form the partner (Yes in Block S4), the requester reports candidates of interface units to be the moving destinations in order of priorities to the responder (Block S5). When the ‘OK’ message is returned, the requester moves the call with a failure to other interface unit, and if the communication information (information table) has not been damaged, the requester also moves the communication information of the call to the interface unit at the moving destination (Blocks S6, S7).

In a case in which the deterioration in QoS is caused by the failure at the interface unit, the communication information also may be damaged. In such a case, the communication information to be used in the moving destination interface unit is set as a default value.

If the moving of the call has completed normally, the requester reports a message showing the fact the call has been already moved to the responder, and if the response is returned from the responder (communication partner) (Yes in Block S9), the communication is continued through the interface unit of the moving destination (Block S10).

If the ‘NO’ message is received in any one of Block S2, S4, S6, S7 and S9, the requester determines the possibility of continuing the communication at the interface unit (interface unit of which the failure is determined) before moving the call (Block S11). If the continuation is impossible, the call is disconnected (Block S13), only in the case of possibility, the communication is continued at the interface unit before moving the call (Block S12).

Such a case that the call has not been moved and the call has been continued, there may be such a reason that the moving destination interface unit has no free space, there is not any interface unit capable of being connected to a current communication partner, the moving destination interface unit may not be guaranteed its QoS. If it is impossible for the interface unit before moving the call to continue the communication with such a reason left as it is, the call is to be disconnected.

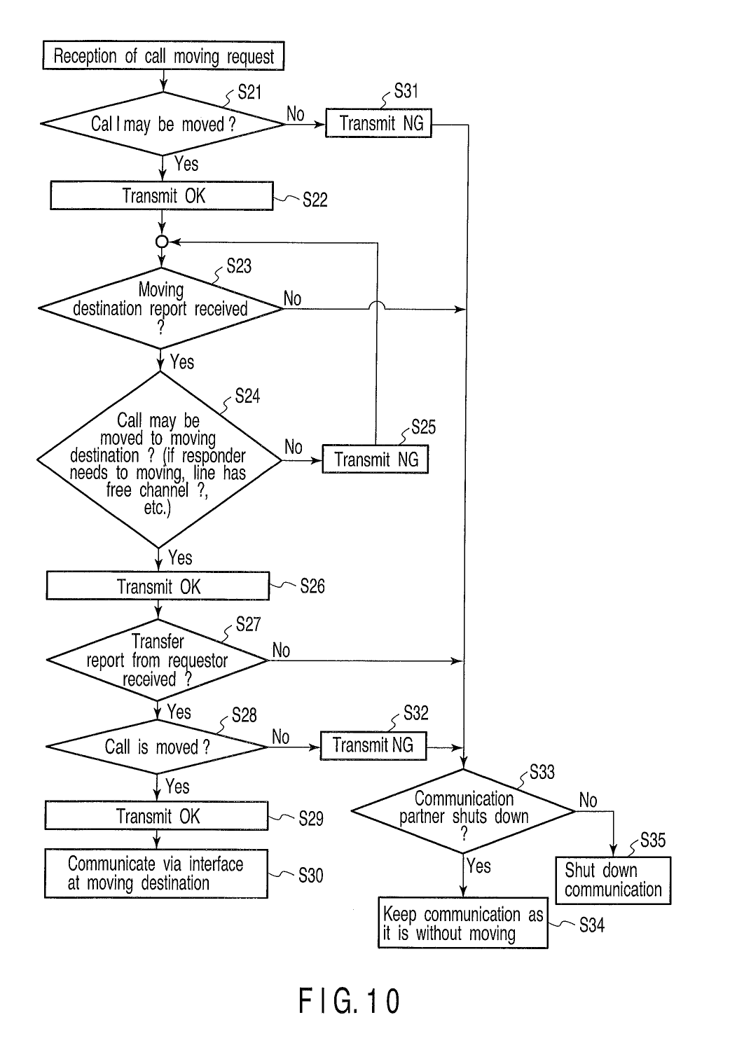

FIG. 10 shows a flowchart illustrating a processing procedure in moving the call to be performed by the responder. In FIG. 10, when receiving the call moving request message from the requester, the responder determines the possibility of the call moving (Block S21). In Block S21, if the request for a change in interface unit from the requester is not allowed (No Block S21), the responder returns the ‘NG’ message (Block S31), and continues the communication as it is. Other than such a case, the responder returns the ‘OK’ message (Block S22).

Next, when receiving the moving destination report message from the requester (Yes in Block S23), the responder determines whether or not the call may be moved to the reported moving destination (Block S24), only in the case that the call can be moved (Yes in Block S24), the responder returns ‘OK’ message (Block S26). After this, the requester stops to transmit the moving destination message.

In a case in which the interface unit at the responder is also changed due to a change in interface unit of the requester, if there is not any free channel in the relevant line, the responder returns an ‘NG’ message to refuse moving of the call (Block S25), and the communication is continued as it is. After this, as long as the responder continues to receive the moving destination report messages, the loop of Blocks S23-S25 are repeated.

After transmitting the ‘OK’ message in Block S26, if the moving report message from the requester is received (Yes in Block S27), the responder also moves the call (Block S28), and if the moving has been completed normally, the ‘OK’ message is returned (Block S29). Then, the communication is continued via the interface at the moving destination (Block S30). If it is impossible for the responder to switch the communication, the responder transmits the ‘NG’ message (Block S32), and the communication is continued as it is without the moving of the interface unit for the call.

If any one of Blocks S21, S23, S27 and S28 has determined ‘No’, it is determined whether the disconnection from the communication partner is performed or not (Block S33). In response to the determination result, the call is continued (Block S34) or disconnected (Block S35).

In the procedure given above, if the call has been moved to any one of the LAN interface units 121-12n for the last time, the call is moved to the line interface unit 13.

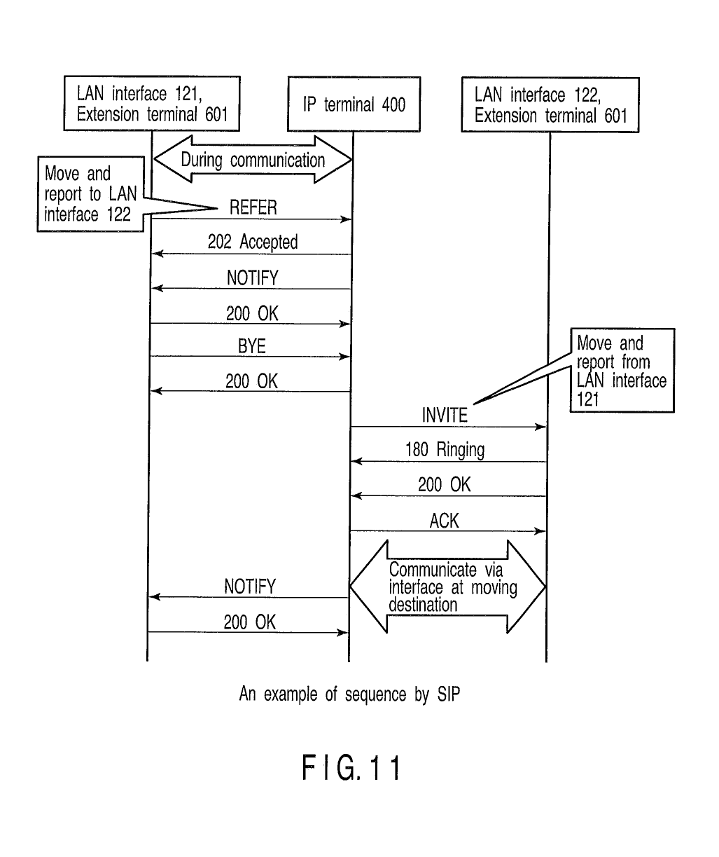

FIG. 11 shows a sequence view illustrating a moving procedure for the call by the use of the SIP protocol. It is assumed that the SIP has been implemented on the IP terminal 400 of FIG. 1. In FIG. 11, it is assumed that the external terminal 601 which is connected to the exchange apparatus 200 communicates with the IP terminal 400 through the LAN interface unit 121. Further, in such a situation, it is assumed that the LAN interface unit 121 has detected the deterioration in QoS and the LAN interface unit 122 has been selected as the moving destination for the call. The LAN interface unit 121 then transmits a ‘REFER’ message to the IP terminal 400. When ‘202 Accepted’ message has been returned for the ‘REFER’ message, messages based on the rule of the SIP are transmitted and received between the LAN interface units 121 and 122.

Finally, when a ‘200 OK’ message for a ‘BYE’ message from the LAN interface unit 121 has been transmitted from the IP terminal 400, the IP terminal 400 immediately transmits an ‘INVITE’ message to the LAN interface unit 122. In response to this ‘INVITE’ message, a message in order to establish a new call is transmitted and received, moving of the call from the LAN interface unit 121 to the LAN interface unit 122 has been completed. It is preferable for the communication information, which should be transmitted and received in the foregoing sequence, to be described in the SIP message in a text form. In this way, the communication between the extension terminal 601 and the IP terminal 400 is continued via the LAN interface unit 122. The sequence of FIG. 11 applies a transfer function of SIP. In the embodiment, the sequence shown in FIG. 11 is automatically executed between the interface unit with the deterioration in QoS detected therein and its communication partner. Then, the call may be moved smoothly without imposing a burden on the caller and without having to operate for inputting a special number.

As described above, in this embodiment, when the deterioration in QoS at the LAN interface unit has been detected, the call is moved to other LAN interface unit, for instance, in a form using a reservation transference function. That is, a communication route of the call of which the QoS has been deteriorated is switched to other communication route via another interface unit. Since there are a plurality of interface units to be switching destinations, it is decided that which of the interface units should accept the moving of the call in accordance with the defined order of priority.

The order of priority, as shown in FIG. 5, may be the descending order of the number of free channels, the descending order of excellence, in the order of the number given to the interface unit, etc. Especially, by switching the communication routes of the call so as to pass through the guarantee type network such as the ISDN, the QoS may be guaranteed.

As mentioned above, according to the embodiment, even if the QoS of the call during establishment has deteriorated, the deteriorated QoS may be improved with the communication through the call still continued. That is, not from the next communication, the quality of the deteriorated QoS becomes improved. Therefore, the caller may save trouble to disconnect the call once. Even if the deterioration in QoS has resulted from the failure at the interface unit, since the communication may be continued by using other interface unit, the QoS can be surely guaranteed.

As given above, the exchange apparatus may make a the communication link which has been established detour to other network, thereby a telephone system configured to accurately guarantee the QoS of the call being in communication can be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, comprising an exchange apparatus to be connected to a best-effort type network and a telephone terminal to be connected to the exchange apparatus, wherein
the exchange apparatus includes:
a first interface unit which is connected to the best-effort type network;
a second interface unit which forms a communication route differing from the first interface unit;
a detection unit which detects deterioration in a quality of service of a call during establishment between the telephone terminal and its partner via the first interface unit and the best-effort type network; and
a call moving unit which moves the call to a communication route passing through the second interface unit when the deterioration is detected.

2. The telephone system according to claim 1, further comprising:
a plurality of the second interface units, wherein the call moving unit moves the call to any one of the second interface units which is decided in a defined order of priority among the plurality of second interface units when the deterioration is detected.

3. The telephone system according to claim 2, wherein
the defined order of priority is order of the number of free channels for each of the plurality of second interface units.

4. The telephone system according to claim 2, wherein
the defined order of priority is order of the Quality of Service for each of the plurality of second interface units.

5. The telephone system according to claim 2, wherein
the defined order of priority is order of numbers to be put to the plurality of second interface units.

6. The telephone system according to claim 1, wherein
the call moving unit reports a message for inquiring a possibility of moving the call to the partner when the deterioration is detected and moves the call to the communication route when an allowable response is received for the message.

7. The telephone system according to claim 1, wherein
the exchange apparatus further comprises a communication information moving unit which moves communication information related to the moved call to the second interface unit of a moving destination from the first interface unit.

8. The telephone system according to claim 1, wherein
the second interface unit is connected to a guarantee type network, and
the communication route passes through the guarantee type network.

9. An exchange apparatus which is connected to a best-effort type network and a telephone terminal, comprising:
a first interface unit which is connected to the best-effort type network;
a second interface unit which forms a communication route differing from the first interface unit;
a detection unit which detects deterioration in Quality of Service of call during establishment between the telephone terminal and its partner via the first interface unit and the best-effort type network; and
a call moving unit which moves the call to a communication route passing through the second interface unit when the deterioration is detected.

10. The exchange apparatus according to claim 9, further comprising:
a plurality of the second interface units, wherein
the call moving unit moves the call to any one of the second interface units which is decided in a defined order of priority among the plurality of second interface units when the deterioration is detected.

11. The exchange apparatus according to claim 10, wherein
the defined order of priority is order of the number of free channels for each of the plurality of second interface units.

12. The exchange apparatus according to claim 10, wherein
the defined order of priority is order of the Quality of Service for each of the plurality of second interface units.

13. The exchange apparatus according to claim 10, wherein
the defined order of priority is order of numbers to be put to the plurality of second interface units.

14. The exchange apparatus according to claim 9, wherein
the call moving unit reports a message for inquiring a possibility of moving the call to the partner when the deterioration is detected and moves the call to the communication route when an allowable response is received for the message.

15. The exchange apparatus according to claim 9, further comprises a communication information moving unit which moves communication information related to the moved call to the second interface unit of a moving destination from the first interface unit.

16. The exchange apparatus according to claim 9, wherein
the second interface unit is connected to a guarantee type network, and
the communication route passes through the guarantee type network.
